(19) United States
(12) Patent Application Publication
(10) Pub. No.: US 2015/0052604 A1
(43) Pub. Date: Feb. 19, 2015

(54) METHOD AND DEVICE FOR PROTECTING USER PRIVATE DATA OF APPLICATION PROGRAM

(71) Applicant: Tencent Technology (Shenzhen) Company Limited, Shenzhen (CN)

(72) Inventor: Yong Chen, Shenzhen (CN)

(21) Appl. No.: 14/528,418

(22) Filed: Oct. 30, 2014

Related U.S. Application Data
(63) Continuation of application No. PCT/CN2013/088345, filed on Dec. 2, 2013.

(30) Foreign Application Priority Data
Feb. 27, 2013 (CN) CN 201310061085.X

(51) Int. Cl. G06F 21/62; G06F 21/53

(52) U.S. Cl. CPC G06F 21/629; G06F 21/53
USPC 726/22

(57) ABSTRACT

The disclosure provides a device for protecting user private data of an application program, including: a space managing module configured to create a normal space and one or more private spaces and setting one or more protected application programs; a monitoring module configured to monitor a switching instruction for switching from a current space to a target space, and inform a space switching module after receiving the switching instruction; the space switching module configured to back up user data of the protected application programs into a memory area corresponding to the current space, and after receiving the switching instruction, replace current user data of the corresponding protected application programs with the user data of the protected application programs, backed up in a memory area of the target space. By using the present disclosure, security of the user private data in the application programs can be enhanced.

### CROSS-REFERENCES TO RELATED APPLICATIONS

This application is a continuation of International Application No. PCT/CN2013/088345, filed on Dec. 2, 2013, which claims priority to Chinese patent application No. 201310061085.X, filed on Feb. 27, 2013, the content of which are incorporated herein by reference in their entirety.

### TECHNICAL FIELD

The present application relates to the technical field of data processing technique of a data processing apparatus, particularly to a method and device for protecting user private data of an application programs in a data processing apparatus.

### BACKGROUND

In current work and life, apparatuses having data processing capabilities such as a computer, a mobile phone, a palm computer and a tablet computer, etc. have been used widely. Particularly, portable data processing apparatuses such as a mobile phone, a palm computer and a tablet computer, etc. have become essential tools carried along by people.

Along with increase of the processing capability of the data processing apparatuses and development of information technology, application programs (APP) running on the data processing apparatus are getting more and more. Particularly, the application programs on a portable data processing apparatus develop in a blowout speed. For example, the application programs for mobile phones continuously emerging currently, particularly social application programs such as WeChat, MicroBlog and MoMo, etc. attract a huge number of users, and the users prefer to communicate with each other by using this kind of application programs.

During the use of the application programs, there are a lot of private data in the user data of the application programs, such as data on contact information and chat records and the like. Thus, the private protection problem along therewith also becomes more and more important. For example, during the process in which the user is using a mobile phone, if the screen of the mobile phone of the user is seen by another person (this kind of cases often occur), the mobile phone is lost, or the mobile phone needs to be lent to another person, then it will result in the leakage of the user private data of the application programs in the mobile phone. Therefore, how to effectively protect user private data of application programs has been known as one of the technical hotspots in the art.

FIG. 1 is a schematic diagram of an existing protection scheme of user private data of application programs. Referring to FIG. 1, the protection scheme sets up a coded lock protection function for an application program. If a certain application program is locked, i.e., an access password is set for it, then when a user accesses the locked application program, a password interface shown in the right half of the figure will be ejected out, and the user can not enter into the application program and access the user data within the application program until a correct password has been input into the password interface.

However, the prior art shown in FIG. 1 has the following disadvantages:

The scheme directly limits the right for a user to access an application program. Although the other people can not know user private data of an application program at the first time, the scheme explicitly prompt to other people that “the application program has a secret therein, but it can not be accessed until a password is entered”. This explicit prompt may result in that other people generate a motive for cracking the password while the password can be cracked easily by using the existing password cracking technique, thus causing leakage of the user private data of the application program.

### SUMMARY

In view of this, the present disclosure is to provide a method and device for protecting user private data of an application program to enhance security of the user private data in the application program.

The technical solution of the present disclosure is implemented as follows:

A method for protecting user private data of an application program includes:

creating a normal space and one or more private spaces and setting one or more protected application programs, and each of a current space and a target space corresponding to one of the normal space and the private spaces;

monitoring a switching instruction for switching from the current space to the target space;

backing up user data of the protected application programs into a memory area corresponding to the current space, and after receiving the switching instruction, replacing current user data of the protected application programs with the user data of the protected application programs backed up in a memory area of the target space.

A device for protecting user private data of an application program comprises:

a space managing module is configured to create a normal space and one or more private spaces and set one or more protected application programs, and each of a current space and a target space corresponding to one of the normal space and the private spaces;

a monitoring module is configured to monitor a switching instruction for switching from a current space to a target space, and inform a space switching module after receiving the switching instruction;

the space switching module is configured to back up user data of the protected application programs into a memory area corresponding to the current space, and after receiving the switching instruction, replace current user data of the protected application programs with the user data of the protected application programs backed up in a memory area of the target space.

A non-transitory computer readable recording medium having embodied thereon a computer program to execute the following steps:

creating a normal space and one or more private spaces and setting one or more protected application programs, and each of a current space and a target space corresponding to one of the normal space and the private spaces;

monitoring a switching instruction for switching from the current space to the target space;

backing up user data of the protected application programs into a memory area corresponding to the current space, and after receiving the switching instruction, replacing current user data of the corresponding protected application programs with the user data of the protected application programs, backed up in a memory area of the target space.

Compared to the prior art, the present disclosure can create a normal space and a private space(s), and the data processing apparatus only corresponds to one space when operating, can switch between the normal space and the private space, backs up current user data of the protected application programs into a memory area corresponding to the current space before the switching, and after the switching, replacing current user data of the protected application programs with the user data of the protected application programs backed up in a memory area of the target space. Therefore, the present disclosure can separate user data of a protected application program in different spaces, where although the categories, amounts, icons and even functions, etc. of application programs seen in different spaces are identical, the user data of the application programs to be protected are different, effectively protecting user private data of application programs; meantime, since the categories, amounts, icons and even functions, etc. of application programs seen in different spaces are identical, other people will be made to misunderstand that there is no private data, to achieve such an object as “making other people not know that I have private data”, thus avoiding the motive of other people to crack private data, and enhancing security of private data.

### BRIEF DESCRIPTION OF THE DRAWINGS

FIG. 1 is a schematic diagram of an existing protection scheme of user private data of an application program;

FIG. 2 is a schematic flow chart of a method for protecting user private data of an application program according to the embodiment of the present invention;

FIG. 3 is a schematic diagram of protecting user private data of an application program through switching spaces according to the embodiment of the present invention; and

FIG. 4 is a schematic block diagram of a device for protecting user private data of an application program according to the embodiment of the present invention.

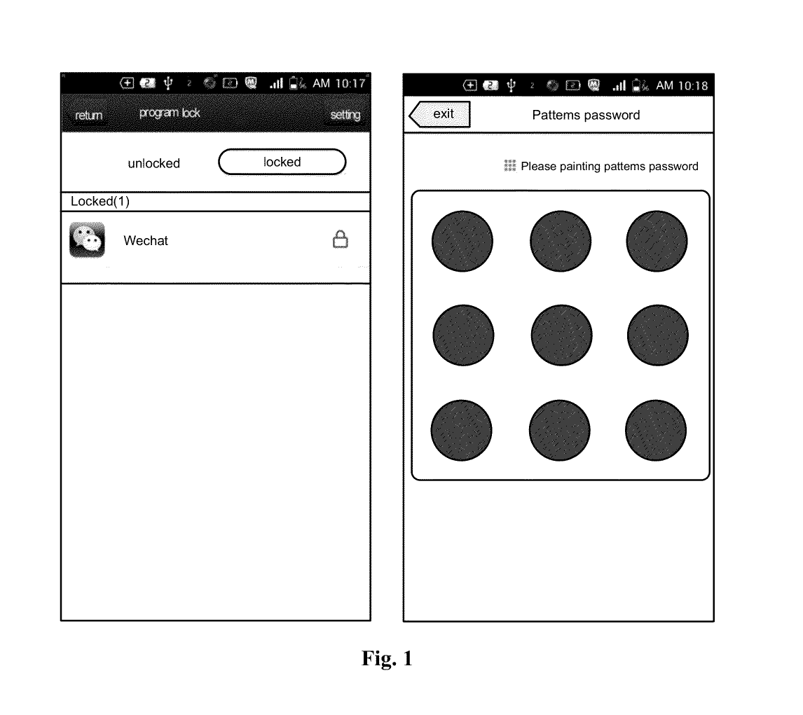

### DETAILED DESCRIPTION

The present disclosure is further described in detail below in conjunction with the drawings and the specific embodiments.

The method and device described by the present disclosure is applicable to all data processing apparatuses such as a computer, a smart mobile phone, a palm computer and a tablet computer, etc., particularly, to portable data processing apparatuses such as a mobile phone, a palm computer and a tablet computer, etc. The application program described in the present disclosure refers to the application program running on the data processing apparatus, and the user data in the application program comprises data related to a logged in user in the application program, for example, attribute information of the user, contact information, and communication records with contacts such as chat records, etc that is stored in the memory of the data processing apparatus.

In the following embodiments, the present disclosure will be described by taking protecting user private data of an application program on a mobile phone as an example.

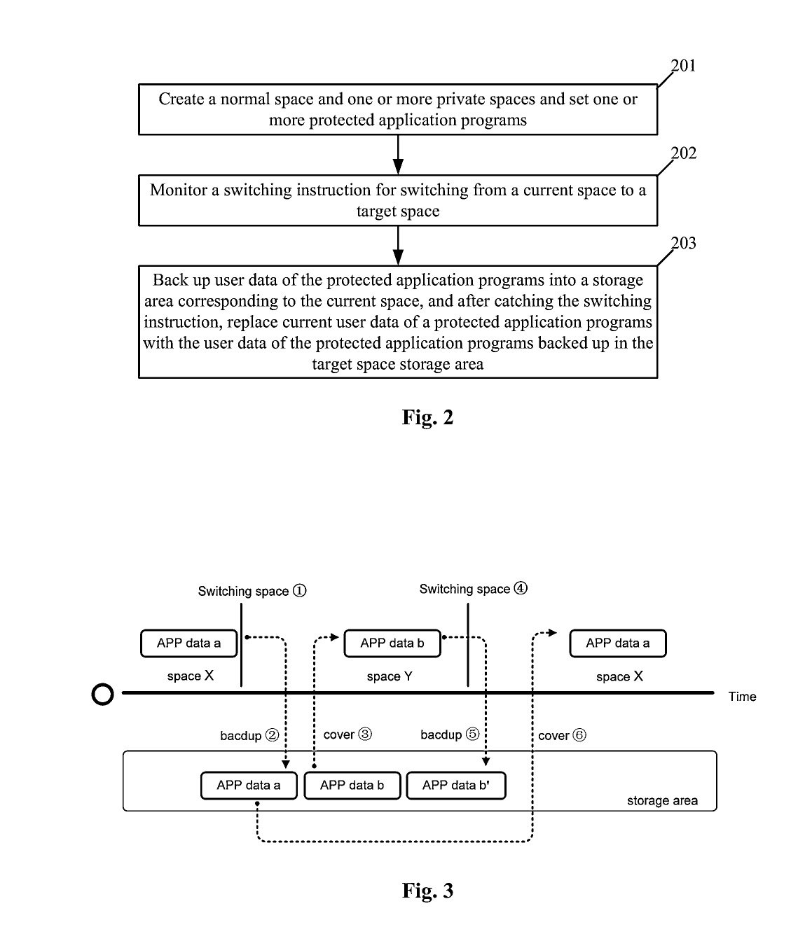

FIG. 2 is a schematic flow chart of a method for protecting user private data of an application program according to the embodiment of the present invention.

Referring to FIG. 2, in step 201, a normal space and one or more private spaces (the number of the private space(s) can be one or more) is created and one or more protected application programs is set, and each of a current space and a target space corresponds to one of the normal space and the private spaces.

In step 202, a switching instruction for switching from the current space to the target space is monitored.

In step 203, user data of the protected application programs is backed up into a memory area corresponding to the current space, and after receiving the switching instruction, current user data of the respective application programs (i.e., the protected application programs) is replaced with the user data of the protected application programs backed up in a memory area of the target space.

In step 201, the created space is substantially a kind of working mode of the mobile phone, and when creating a space, it needs to create an ID for the space, and create a memory area corresponding to the space and assign it to the space, the memory area being used for storing user data backed up by the space. In the created space, private protection is not set for a normal space which acts as a space that can be used publicly; the private space is a space parallel to the normal space, and corresponding protected application programs are set in the private space, and these protected application programs are independent from each other in terms of user data in the normal space and the user data in the private space.

The mobile phone only corresponds to one space in operation, i.e., one working mode, and can switch to another space based on a switching instruction of a user. For example, the mobile phone corresponds to a normal space in default operation, can switch from the normal space to a certain private space, i.e., switch to a private working mode, and can also switch from a private space to a normal space, i.e., switch to a normal working mode. The spaces will not influence normal operation of the mobile phone, but will influence user data of the protected application program, i.e., non-user data (including categories, amount, icons and etc. of the application program and other data except those related to the user, in the each application program) of any application program and user data of a non-protected application program are identical in the normal space and the private space, but the protected application program corresponds to mutually independent user data in the normal space and the private space. That is, user data operated in the normal space (i.e., normal working mode) and user data operated in the private space (i.e., private working mode) by a same protected application program are different. Through this kind of processing, the user private data and non-private data of the protected application program can be made separated from each other, avoiding leakage of the private data.

The number of the private spaces created by the present disclosure can be one or more. For each private space, the present disclosure can set one or more protected application program in the private space. The protected application programs protected by each private space can be identical or different.

In step 203, a specific method for backing up the current user data of the protected application program can be implemented by the application program providing a user data storage path (for short in the specification, user data path) to the outside, that is: each kind of application program provides its user data path to the outside. The present disclosure can find the current user data, which are usually one or more files or folders, of the protected application program based on the user data path, and then back up the user data into a memory area corresponding to the current space.

For example, with regard to a certain specific application program, its user data are all stored under a user data path corresponding to the application program, and the application program will read or write user data with respect the user data path no matter what space it is in. Merely, for the protected application program, the present disclosure needs to back up the user data of the protected application program into a memory area corresponding to the current space. After receiving the switching instruction, the user data of the protected application program backed up in the memory area of the target space is used to replace the current user data of the protected application program, i.e., replace the data under the user data path of the protected application program.

In the above step 203, there can be a plurality of specific modes for backing up user data of the protected application program into a memory area corresponding to the current space, for example, the preferred two kinds are a central backup mode and a synchronous backup mode.

1) Central backup mode: i.e., the backup is not executed until receiving a switching instruction for switching from a current space to a target space, that is, the user data of the protected application program is backed up centrally into a memory area corresponding to the current space.

2) Synchronous backup mode: i.e., in the course of running the protected application program, user data of the running protected application program is backed up synchronously to a memory area corresponding to the current space. Thus after receiving the switching instruction, there is no need for central backup, which saves the switching time, increases the switching speed, and further avoids leakage of user private data due to an over slow switching speed.

In the above central backup mode, since the backing up is executed after receiving the switching instruction, and the private space involved in the switching this time has been known at that time, that is, switching from which private space to the normal space or from the normal space to which private space. Therefore, at the time of backing up, it is enough to only backing up the user data of the one or more protected application programs of the private space, and then the user data of the one or more protected application programs of the private space in the memory area of the target space is used to replace the current user data of the corresponding one or more protected application programs (i.e., the application programs protected by the private space involved in this switching). The specific processing mode is as follows.

After receiving a switching instruction for switching from a current space to a target space, if the current space is the normal space and the target space is the private space, then the subsequent steps comprise: backing up the current user data of the one or more protected application programs of the private space into a memory area corresponding to the current normal space, and replacing current user data of the corresponding one or more protected application programs (i.e., the application programs protected by the private space) with the user data of the one or more protected application programs of the private space backed up in the memory area of the private space; if there are a plurality of application programs protected by the private space, such as application program A and application program B, then the current user data of application program A is replaced with the user data of application program A backed up in the memory area of the private space, and the current user data of application program B is replaced with the user data of application program B backed up in the memory area of the private space.

After receiving a switching instruction for switching from a current space to a target space, if the current space is the private space and the target space is the normal space, then the subsequent steps comprise: backing up the current user data of the one or more protected application programs of the private space into a memory area corresponding to the private space, and replacing current user data of the corresponding one or more protected application programs (i.e., the application programs protected by the private space) with the user data of the one or more protected application programs of the private space, backed up in the memory area of the normal space.

In the above synchronous backup mode, if the current space is the normal space, since it is not known which private space is expected to switch to, in the course of running a plurality application program, it needs to synchronously back up the user data of the one or more running protected application programs of any private space into a memory area corresponding to the current space, and after receiving a switching instruction for switching from a current space to a target private space, only the user data of the one or more protected application programs of the target private space in the memory area of the target private space is used to replace current user data of the corresponding one or more protected application programs (i.e., the application programs protected by the target private space).

In the above synchronous backup mode, if the current space is the private space, then when running one or more protected application programs of the current private space, it is enough to only back up the user data of the one or more protected application programs of the current private space into a memory area corresponding to the current private space, and after receiving a switching instruction for switching from a current private space to a normal space, the user data of the one or more protected application programs of the private space (i.e., the private space before switching) in the memory area of the normal space is used to replace current user data of the corresponding one or more protected application programs (i.e., the one or more application programs protected by the private space before switching).

In a preferred scheme of the present disclosure, in the course of creating a space or after creating a space: for the private space, authentication information corresponding to the private spaces and a designated input mode for inputting the authentication mode can be further set; for the normal space, a shortcut operation for switching back to the normal space is further set, for example, “HOME” key or an off screen operation can be set as the shortcut operation for switching back to the normal space.

In step 202, receiving a switching instruction for switching from a current space to a target space specifically comprises the following modes:

1) in case that the current space is the normal space, monitoring whether the authentication information input according to the designated input mode is received, and if receiving, then determining whether the authentication information is the authentication information of a certain private space; and after determining the authentication information is the authentication information of a certain private space, then determining the switching instruction for switching from the current space to the private space is caught, the private space being the target space.

Thus, there can be provided double obstacles for switching from a normal space to a certain private space. The first obstacle is needing to input authentication information according to a designated input mode. This kind of input mode can be set by a user, and usually only the user himself knows the input mode. For example, only pressing which one or more shortcut keys first and then input the authentication information can be determined as the designated input mode. The second obstacle is authentication information, i.e., the input authentication information must be authentication information corresponding to a certain private space. Through the above double obstacles, difficulty for other users to enter the private space is further increased, thus enhancing security of private data. Simultaneously, the use of this mode does not need to prompt the user to input a password, achieves such an object of “making the other persons be not aware of I have private data”, and thus avoids motives of other persons for cracking the private data, enhancing security of the private data.

2) In case that the current space is the private space, monitoring whether the designated shortcut operation occurs; and when receiving the designated shortcut operation occurs, determining the switching instruction for switching from the current space to the normal space is caught, the normal space being the target space.

Thus, when a user is operating private data of the private space, if another person wants to have a look at the user's mobile phone screen, or wishes to borrow the user's mobile phone, the user can promptly switch back to the normal space from the private space such that no one knows that the user is operating the private data a moment ago. When the other person see the mobile phone screen, the information on the mobile phone screen are all non-private data in the normal space, and has no difference from a normal mobile phone screen. This makes other users be incapable finding there is private data in the mobile phone, achieves such an object of “making the other persons be not aware of I have private data”, and thus avoids motives of other persons for cracking the private data, enhancing security of the private data.

3) In case that the current space is the private space, monitoring a duration of no operation; when the duration of no operation reaches a predetermined duration (for example, 30 seconds), then determining the switching instruction for switching from the current space to the normal space is caught, the normal space being the target space; or when the current space is the private space, then monitoring whether there occurs an off screen event, and if so, then determining the switching instruction for switching from the current space to the normal space is caught.

Thus when the user does not use the mobile phone for a long time, for example, when the user forgets the mobile phone on a desk, the mobile phone can automatically switch from the private space to the normal space, thus even if another person picks up the mobile phone, what he sees is also the non-private data in the normal space, with no difference from a normal mobile phone screen existing. This makes other users be incapable finding there is private data in the mobile phone, achieves such an object of “making the other persons be not aware of I have private data”, and thus avoids motives of other persons for cracking the private data, enhancing security of the private data.

The scheme of the present disclosure will be further described below in one specific instance.

FIG. 3 is a schematic diagram of protecting user private data of an application program through switching spaces according to the embodiment of the present invention. Referring to FIG. 3, assuming a space X is a normal space, a space Y is a private space, and a protected application program is APP, then the whole switching process comprises:

(1) APP operates in space X, its user data is APP data a, and after monitoring a switching instruction for switching from space X to space Y, executing (2).

(2) Backing up APP data a to a memory area corresponding to space X.

(3) Using user data of APP in a memory area of space Y, i.e., APP data b (the user data is the user data backed up last time, and at the beginning, the user data backed up in the memory area of the private space can be considered empty in default) to overwrite the current user data of APP, i.e., APP data a, to complete the switching process this time.

(4) When it needs to switch back to space X from space Y, executing (5).

(5) Backing up current user data of APP into the memory area of space Y, and since the APP data b may generate a variation to change into b′ during use, the data backed up at this time becomes APP data b′.

(6) Using APP data a backed up in the memory area of space X to overwrite current user data of the present APP, i.e., APP data b′ to recover the user data of APP into a state when space X is switched into space Y, thus completing the switching process.

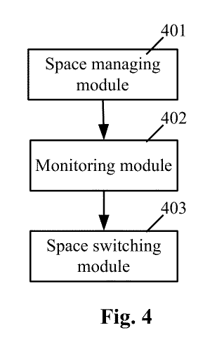

Corresponding to the above mentioned method, the present disclosure further discloses a device for protecting user private data of an application program. FIG. 4 is a schematic block diagram of a device for protecting user private data of an application program according to the embodiment of the present invention. Referring to FIG. 4, the device comprises:

a space managing module 401 is used to create a normal space and one or more private spaces and set one or more protected application programs, and each of a current space and a target space corresponds to one of the normal space and the private spaces;

a monitoring module 402 is used to monitor a switching instruction for switching from a current space to a target space, and inform a space switching module after receiving the switching instruction;

the space switching module 403 is used to back up user data of the protected application programs into a memory area corresponding to the current space, and after receiving the switching instruction, replace current user data of the corresponding one or more protected application programs with the user data of the one or more protected application programs, backed up in a memory area of the target space.

In another preferred embodiment according to the device of the present application, the space managing module 401 is used to create a normal space and one or more private spaces, and set corresponding protected application programs in each private space. For each private space, the present disclosure can set one or more protected application program of the private space.

Corresponding to the central backup mode referring to the method, in a preferred embodiment according to the device of the present application, the space switching module 403 is further configured to firstly back up user data of the protected application program into a memory area corresponding to the current space, and then replacing current user data of the protected application program with the user data of the protected application program backed up in the memory area of the target space, after receiving the switching instruction for switching from the current space to the target space.

Specifically, after the space switching module 403 receives the switching instruction for switching from the current space to the target space, if the current space is the normal space and the target space is the private space, then the space switching module 403 backs up the current user data of the one or more protected application programs of the private space into a memory area corresponding to the current normal space, and replaces current user data of the corresponding one or more protected application programs with the user data of the one or more protected application programs of the private space, backed up in the memory area of the private space; if the current space is the private space, and the target space is the normal space, then the space switching module 403 backs up the current user data of the one or more protected application programs of the private space into a memory area corresponding to the private space, and replaces current user data of the corresponding one or more protected application programs with the user data of the one or more protected application programs of the private space backed up in the memory area of the normal space.

Corresponding to the synchronous backup mode referring to the method, in a preferred embodiment according to the device of the present application, the space switching module 403 is configured to: in the course of running the protected application program, synchronously back up user data of the running protected application program into a memory area corresponding to the current space; and after receiving the switching instruction, replace current user data of the corresponding one or more protected application programs with the user data of the protected application program, backed up in the memory area of the target space.

Specifically, if the current space is the normal space, in the course of running a plurality application program, the space switching module 403 needs to synchronously back up the user data of the one or more running protected application programs of any private space into a memory area corresponding to the current space; and after receiving the switching instruction for switching from the current space to a target private space, only replace current user data of the corresponding one or more protected application programs (i.e., the application programs protected by the target private space) with the user data of the one or more protected application programs of the target private space, backed up in the memory area of the target private space. If the current space is the private space, then when running application programs, the space switching module 403 only synchronously backs up the user data of the one or more protected application programs of the current private space into a memory area corresponding to the current private space; and after receiving the switching instruction for switching from the current private space to the target space, replacing current user data of the corresponding one or more protected application programs with the user data of the one or more protected application programs of the private space before the switching, backed up in the memory area of the target normal space.

In a preferred embodiment according to the device of the present application, the space managing module 401 is further configured to: in the course of creating a space or after creating a space: for the private space, set authentication information corresponding to the private spaces and a designated input mode for inputting the authentication information; and, the space managing module 401 is further configured to set a designated shortcut operation for switching back to the normal space.

In a preferred embodiment according to the device of the present application, the monitoring module 402 is configured to: in case that the current space is the normal space, monitor whether the authentication information input according to the designated input mode is received, and if receiving, then determine whether the authentication information is the authentication information of a certain private space; and after determining the authentication information is the authentication information of a certain private space, then determine the switching instruction for switching from the current space to the private space is caught, the private space being the target space.

In another preferred embodiment according to the device of the present application, the monitoring module 402 is configured to: in case that the current space is the private space, monitor whether the designated shortcut operation occurs; and when receiving the designated shortcut operation occurs, determine the switching instruction for switching from the current space to the normal space is caught, the normal space being the target space.

In yet another embodiment according to the device of the present application, the monitoring module 402 is configured to: in case that the current space is the private space, monitor a duration of no operation; when the duration of no operation reaches a predetermined duration, then determine the switching instruction for switching from the current space to the normal space is caught, the normal space being the target space; or when the current space is the private space, then monitor whether there occurs an off screen event, and if so, then determine the switching instruction for switching from the current space to the normal space is caught.

The device described by the present disclosure can be made as software that can be installed on a data processing apparatus, and by using the software, user private data of other application programs on the data processing apparatus, particularly user private data of application programs applicable to a portable data processing apparatus such as a mobile phone, can be protected.

In the several embodiments provided by the present application, it should be understood that the disclosed system, device and method can be implemented by other means. For example, the above mentioned device embodiments are only exemplary. For example, the division of the units is only a logical function division, and can have additional division modes when being implemented in practice. For example, a plurality of units and components can be combined or integrated into another system, or some features can be omitted or not executed.

What are described above are only preferred embodiment of the present invention, and are not used for limiting the present invention. Any modifications, equivalent substitutions and improvements made within the spirit and principle of the present invention are in the scope protected by the present invention.

1. A method implemented in a data processing apparatus for protecting user private data of an application program executing in the data processing apparatus, the data processing apparatus including a memory device, the method comprising:
creating a normal space and one or more private spaces in the memory device and setting one or more protected application programs, and each of a current space and a target space corresponding to one of the normal space and the private spaces;
monitoring a switching instruction for switching from the current space to the target space;
backing up user data of the protected application programs into a memory area corresponding to the current space, and
after receiving the switching instruction, replacing current user data of the corresponding protected application programs with the user data of the protected application programs, backed up in a memory area corresponding tothe target space.

2. The method of claim 1, wherein backing up user data of the protected application program into the memory area corresponding to the current space is in response to receiving the switch instruction.

3. The method of claim 2, wherein setting one or more protected application programs comprises:
for each private space, setting one or more application programs in each private space;
in response to receiving the switching instruction, if the current space is the normal space and the target space is the private space, backing up the current user data of the one or more protected application programs of the private space into a memory area corresponding to the current normal space, and replacing current user data of the corresponding one or more protected application programs with the user data of the one or more protected application programs of the private space, backed up in the memory area corresponding to the private space; and
in response to receiving the switching instruction, if the current space is the private space and the target space is the normal space, backing up the current user data of the one or more protected application programs of the private space into a memory area corresponding to the private space, and replacing current user data of the corresponding one or more protected application programs with the user data of the one or more protected application programs of the private space, backed up in the memory area of the normal space.

4. The method of claim 1, wherein backing up user data of the protected application programs into a memory area corresponding to the current space comprises:
in the course of running the protected application programs, synchronously backing up user data of the running protected application programs into a storage area corresponding to the current space.

5. The method of claim 4, wherein setting one or more protected application programs comprises:
for each private space, setting one or more application programs in each private space;
in response to determining that the current space is the normal space, synchronously backing up user data of the protected application programs into a memory area corresponding to the current space comprises: during the execution of any protected application program of any private space, synchronously backing up user data of the running protected application program into a memory area corresponding to the current space; and replacing current user data of the corresponding protected application programs with the user data of the protected application programs backed up in the memory area of the target space comprises: replacing current user data of the corresponding one or more protected application programs with the user data of the one or more protected application programs of the target private space, backed up in the memory area of the target private space; and
in response to determining that the current space is the private space, synchronously backing up user data of the protected application programs into a memory area corresponding to the current space comprises: when running one or more protected application programs of the current private space, synchronously backing up the user data of the one or more protected application programs of the current private space into a memory area corresponding to the current private space; and replacing current user data of the corresponding protected application programs with the user data of the protected application programs backed up in the memory area of the target space comprises: replacing current user data of the corresponding one or more protected application programs with the user data of the one or more protected application programs of the private space before the switching, backed up in the memory area of the normal space.

6. The method of claim 1 further comprises setting authentication information corresponding to the private spaces and a designated input mode for inputting the authentication information;
said receiving the switching instruction for switching from the current space to the target space comprises: in case that the current space is the normal space, monitoring whether the authentication information input according to the designated input mode is received, and in response to receiving the switching instrcutions, then determining whether the authentication information is the authentication information of a certain private space; and after determining the authentication information is the authentication information of a certain private space, then determining the switching instruction for switching from the current space to the private space is caught, the private space being the target space.

7. The method of claim 1, wherein in the course of creating a space or after creating a space:
for the private space, further setting a designated shortcut operation for switching back to the normal space;
said receiving the switching instruction for switching from the current space to the target space comprises: in case that the current space is the private space, monitoring whether the designated shortcut operation occurs; and when receiving the designated shortcut operation occurs, determining the switching instruction for switching from the current space to the normal space is caught, the normal space being the target space.

8. The method of claim 1, wherein said receiving the switching instruction for switching from the current space to the target space comprises: in case that the current space is the private space, monitoring a duration of no operation; when the duration of no operation reaches a predetermined duration, then determining the switching instruction for switching from the current space to the normal space is caught, the normal space being the target space; or when the current space is the private space, then monitoring whether there occurs an off screen event, and if so, then determining the switching instruction for switching from the current space to the normal space is caught.

9. A device for protecting user private data of an application program, the device comprising:
a space managing module configured to create a normal space and one or more private spaces and set one or more protected application programs, and each of a current space and a target space corresponding to one of the normal space and the private spaces; and
a monitoring module configured to monitor a switching instruction for switching from the current space to the target space, and inform a space switching module after receiving the switching instruction.
wherein the space switching module configured to back up user data of the protected application programs into a memory area corresponding to the current space, and after receiving the switching instruction, replace current user data of the corresponding protected application programs with the user data of the protected application programs, backed up in a memory area of the target space.

10. The device of claim 9, wherein the space switching module is further configured to: after receiving the switching instruction for switching from the current space to the normal space, first, back up user data of the protected application programs into a memory area corresponding to the current space, and then replace current user data of the protected application programs with the user data of the protected application program, backed up in the memory area of the target space.

11. The device of claim 10, wherein the space managing module is further configured to: for each private space, set one or more application programs of each private space; and
the space switching module is further configured to: after receiving the switching instruction for switching from the current space to the target space, if the current space is the normal space and the target space is the private space, then back up the current user data of the one or more protected application programs of the private space into a memory area corresponding to the current space, and replace current user data of the corresponding one or more protected application programs with the user data of the one or more protected application programs of the private space, backed up in the memory area of the target private space; after receiving a switching instruction for switching a current space to a target space, if the current space is the private space, and the target space is the normal space, then back up the current user data of the one or more protected application programs of the private space into a memory area corresponding to the private space, and replace current user data of the corresponding one or more protected application programs with the user data of the one or more protected application programs of the private space, backed up in the memory area of the normal space.

12. The device of claim 9, wherein the space switching module is further configured to: in the course of running the protected application programs, back up user data of the running protected application programs into a memory area corresponding to the current space; and after receiving the switching instruction, replace current user data of the corresponding one or more protected application programs with the user data of the protected application program, backed up in the memory area of the target space.

13. The device of claim 12, wherein the space managing module is further configured to:
for each private space, set one or more application programs in each private space; and
the space switching module is further configured to: if the current space is the normal space, in the course of running any protected application program of any private space, synchronously back up user data of the running protected application program into a memory area corresponding to the current space; and after receiving the switching instruction for switching from the current space to a target private space, replace current user data of the corresponding one or more protected application programs with the user data of the one or more protected application programs of the target private space, backed up in the memory area of the target private space; if the current space is the private space, then when running protected application programs of the current private space, synchronously back up the user data of the one or more protected application programs of the current private space into a memory area corresponding to the current private space; and after receiving the switching instruction, replace current user data of the corresponding one or more protected application programs with the user data of the one or more protected application programs of the private space before the switching, backed up in the memory area of the normal space.

14. The device of claim 9, wherein the space managing module is further configured to set authentication information corresponding to the private spaces and a designated input mode for inputting the authentication information; and
the monitoring module is further configured to: in case that the current space is the normal space, monitor whether the authentication information input according to the designated input mode is received, and if receiving, then determine whether the authentication information is the authentication information of a certain private space; and after determining the authentication information is the authentication information of a certain private space, then determine the switching instruction for switching from the current space to the private space is caught, the private space being the target space.

15. The device of claim 9, wherein the space managing module is further configured to set a designated shortcut operation for switching back to the normal space;
the monitoring module is further configured to: in case that the current space is the private space, monitor whether the designated shortcut operation occurs; and when receiving the designated shortcut operation occurs, determine the switching instruction for switching from the current space to the normal space is caught, the normal space being the target space.

16. The device of claim 9, wherein the monitoring module is further configured to:
in case that the current space is the private space, monitor a duration of no operation;
when the duration of no operation reaches a predetermined duration, then determine the switching instruction for switching from the current space to the normal space is caught, the normal space being the target space; or
when the current space is the private space, then monitor whether there occurs an off screen event, and if so, then determine the switching instruction for switching from the current space to the normal space is caught.

17. A non-transitory computer readable recording medium having embodied thereon a computer program that when executed by a data processing apparatus, cause the data processing apparatus to:
create a normal space and one or more private spaces and setting one or more protected application programs, and each of a current space and a target space corresponding to one of the normal space and the private spaces;
monitor a switching instruction for switching from the current space to the target space;
back up user data of the protected application programs into a memory area corresponding to the current space, and
after receiving the switching instruction, replace current user data of the corresponding protected application programs with the user data of the protected application programs, backed up in a memory area of the target space.
